(19) United States
(12) Patent Application Publication
(10) Pub. No.: US 2010/0143138 A1
(43) Pub. Date: Jun. 10, 2010

(54) Axial flow wind turbine

(76) Inventors: Russel Hugh Marvin, Goshen, CT (US); Drew M. Rocky, Sherman, CT (US); Bret T. Sleicher, Naugatuck, CT (US)

Correspondence Address: TED PAULDING, 10 PENWOOD LA., WETHERSFIELD, CT, 06109, US

(21) Appl. No.: 12/315,943

(22) Filed: Dec. 8, 2008

(51) Int. Cl. F03D 11/00; F01D 5/22

(52) U.S. Cl. 416/179

(57) ABSTRACT

An axial flow wind turbine having forwardly swept blades with an annular ring interconnecting the blade tips. A rearwardly directed rake profile is also provided together with unequal blade spacing.

### BACKGROUND OF THE INVENTION

Wind turbines are available in the prior art with rearwardly swept blades and with blades having forward and rearward rake profiles and such turbines have been satisfactory in general. However, none of the prior art designs has been completely satisfactory in all respects.

It is the general object of the present invention to provide an improved wind turbine design incorporating a number of features, which in the aggregate result in a significant improvement in noise reduction and in overall performance.

### SUMMARY OF THE INVENTION

In accordance with present invention and in fulfillment of the foregoing general object, an axial flow turbine is provided with a hub, which is mounted for rotation about an axis, and which supports a plurality of narrow radially elongated wind responsive blades in circumaxially spaced driving relationship thereabout. The blades have root portions connected with and supported by the hub and remote tip portions spaced radially outwardly from their root portions. Their cross sectional configurations are such that wind impinging thereon results in a substantial aggregate torque rotating the blades and hub in one direction. A forward sweep of each blade in a radial plane is provided by displacing the tip of each blade forwardly and this may be provided by a forwardly inclined angular arrangement of blades with linear centerlines or, preferably, by employing blades with centerlines which curve gradually forwardly with either constant or non-uniform rates of curvature. A means adding mass at the tips of the blades increases centrifugal forces generated during rotation and urges the blades in a direction opposite the direction of rotation and rearwardly to oppose forces generated by wind engaging the blades. Preferably, the means adding weight takes the form of an annular ring interconnecting the blade tips.

Further, the angle of blades with linear centerlines or the rate of curvature of the centerlines is such that movement of the blades is insignificant at operating speeds of the turbine.

Another feature of the invention resides in the provision of blades having rake profiles which are displaced rearwardly in axial planes and in a downwind direction. Here again, blades with straight or curved centerlines may be employed, as well as blades with partially curved centerlines.

Finally, a still further feature of the invention resides in the provision of blades with unequal circumaxial spacing for reduction in noise generation. The blades may be unequally spaced at their root connections with the hub, or in the alternative, root connections may be equal with tip spacing unequal due to variation in blade centerlines.

### DESCRIPTION OF DRAWINGS

FIG. 1 is a schematic front view of a turbine with forwardly swept blades in accordance with the invention,

FIG. 2 is a schematic side view of a turbine illustrating blades with a rearward linear rake,

FIG. 3 is a schematic view of a turbine having blades with a gradually curved rearward rake,

FIG. 4 is a schematic view of a turbine with blades which have an outer portion with a rearward rake, and

FIG. 5 is a schematic front view of a turbine with unequal blade spacing.

### DESCRIPTION OF PREFERRED EMBODIMENTS

Referring particularly to FIG. 1, a turbine is indicated generally therein at 10 with a hub 12, a plurality of circumaxially spaced blades, five (5) shown, at 14, 14 and an annular ring 16 interconnecting the blade tips. The blades are narrow, radially outwardly elongated and configured to respond to wind pressure and provide a torque in one direction. Each blade has a root portion connected with and supported by the hub 12 and a remote tip portion connected with the ring 16. The blade tips are displaced forwardly as a result of centerlines 18, 18, which curve gradually forwardly from their root portions to their tip portions to provide a forward blade sweep. Alternatively, the blades may have linear centerlines angularly arranged to provide a forward sweep. Preferably, the blades have arcuate centerlines as shown with constant angles of curvature selected to cooperate with centrifugal force to provide insignificant blade movement at operating speeds. As shown, the blades 14, 14 have tip displacements of approximately nine degrees, although tip displacements in the range one tenth of one degree to twenty degrees are contemplated.

The annular tip ring 16 interconnecting the blade tips, in addition to enhancing the generation of centrifugal force, tends to minimize vortices adjacent the blade tips and as a result noise generation is reduced and turbine performance enhanced. Twisting of the long narrow blades about their centerlines is also reduced by the ring 16.

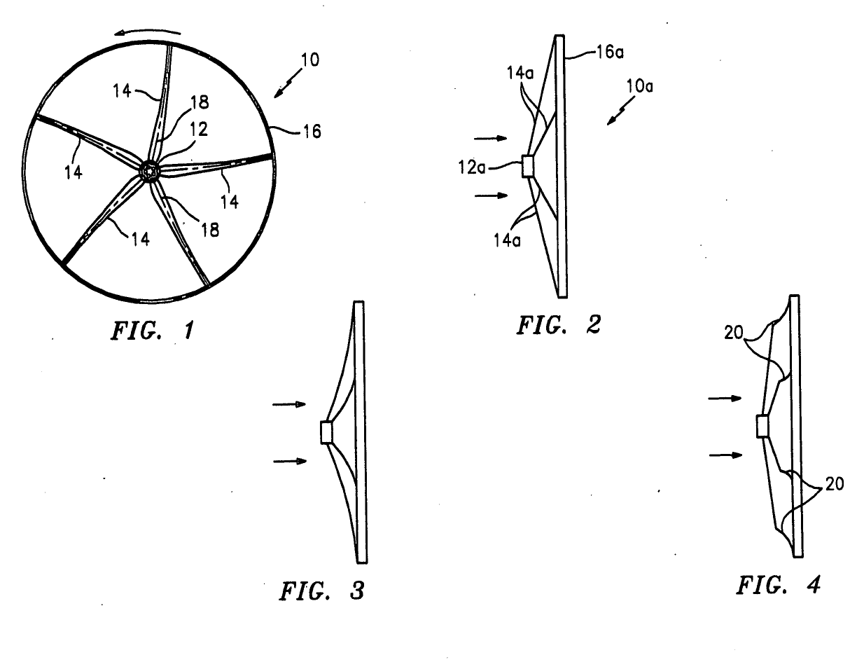

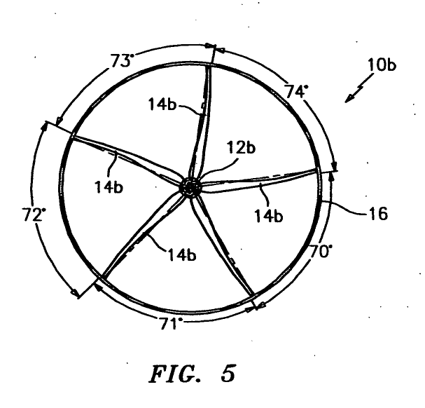

Turbine 10a, best illustrated in FIG. 2, has a hub 12a, blades 14a, 14a and an end ring 16a. As will be obvious from an inspection of the drawing, the blades 14a, 14a have a rake profile with their tip portions displaced rearwardly, or downwind, in relation to their root potions. The blades have linear centerlines 18a, 18a in FIG. 2 but gradually curved centerlines as at 18b, 18b in FIG. 3 are contemplated as well as blades having only portions 20,20 near their tips curved rearwardly as in FIG. 4.

Irrespective of the precise configuration, the displacement of each blade tip portion relative to its root portion should fall in the range of one degree to fifteen degrees and, preferably, the displacement should be approximately five degrees.

In FIG. 5 turbine 10b has a hub 12b, blades 14b, 14b, and an end ring 16b. The blades 14b, 14b may have any of the configurations described above but the circumaxial spacing thereof must be unequal in accordance with another aspect of the present invention. As shown, the blades 14b, 14b have gradually curving centerlines 18b, 18b in a forward sweep configuration as described above and their tip portions are unequally spaced circumaxially, spacing progressing from seventy degrees to seventy four degrees for the five blades shown. The root spacing is equal in FIG. 5 but the tip spacing unequal, but it will be obvious that unequal spacing may be provided at both root and tip portions of the blades. Substantial reduction in noise generation is achieved with the configuration shown.

From the foregoing it will be apparent that each of the features of the invention has merit either in noise reduction or in improvement in performance. In the aggregate, substantial overall improvements in both noise reduction and in performance are achieved.

1. An axial flow turbine for use in wind turbine electrical generating systems comprising a hub mounted for rotation about an axis and carrying a plurality of narrow radially elongated wind responsive blades in circumaxially spaced driving relationship there about, each blade having a root portion connected with and supported by the hub and a remote tip portion spaced radially outwardly from the root portion, the cross sectional configuration of the blades between their root and tip portions being such that wind impinging thereon results in a substantial aggregate torque rotating the blades and hub in one direction, each blade having a sweep profile with a tip portion displaced forwardly in a radial plane in relation to its root portion, and means adding mass at the tips of the blades whereby to increase the centrifugal force generated during rotation and urge the blades radially in a direction opposite the direction of rotation and toward a linear centerline condition.

2. An axial flow turbine as set forth in claim 1 wherein the blades have linear centerlines.

3. An axial flow turbine as set forth in claim 1 wherein the blade centerlines curve gradually.

4. An axial flow turbine as set forth in claim 3 wherein the longitudinal centerline of each blade has a constant rate of curvature from its root to its tip portion.

5. An axial flow turbine as set forth in claim 1 wherein said means adding mass takes the form of an annular ring interconnecting the blade tips.

6. An axial flow turbine as set forth in claim 1 wherein the longitudinal curvature of the blades and the tip mass is selected in relation to centrifugal force such that centrifugal and wind generated forces balance and radial movement of the blade tips relative to the hub is insignificant at operating speeds of the turbine.

7. An axial flow turbine as set forth in claim 1 wherein the angular displacement of each blade tip portion from the hub center through the point of attachment of the blade to the hub falls in the range of one tenth of one degree to twenty degrees.

8. An axial flow turbine as set forth in claim 1 wherein the angular displacement of each blade tip portion from the hub center through the point of attachment of the blade to the hub is approximately nine degrees.

9. An axial flow turbine as set forth in claim 1 wherein a pair of turbines are provided each with the characteristics set forth, and wherein an accelerator mounted on a tower supports the turbines on opposite sides thereof.

10. An axial flow turbine for use in wind turbine electrical generating systems comprising a hub mounted for rotation about an axis and carrying a plurality of narrow radially elongated wind responsive blades in circumaxially spaced driving relationship there about, each blade having a root portion connected with and supported by the hub and a remote tip portion spaced radially outwardly from the root portion, the cross sectional configuration of the blades between their root and tip portions being such that wind impinging thereon results in a substantial aggregate torque rotating the blades and hub in one direction, and each blade having a rake profile with a tip portion displaced rearwardly in relation to its root portion in an axial plane and in a downwind direction, and means adding mass at the tips of the blades whereby to increase the centrifugal force generated during rotation and urge the blades axially in a direction opposite the direction of wind flow.

11. An axial flow turbine as set forth in claim 10 wherein the axial displacement of each blade tip portion relative to its root portion falls in the range of one degree to fifteen degrees.

12. An axial flow turbine as set forth in claim 10 wherein the axial displacement of each blade tip portion relative to its root portion is approximately five degrees.

13. An axial flow turbine as set forth in claim 10 wherein the blade centerlines are substantially linear.

14. An axial flow turbine as set forth in claim 10 wherein the blade centerlines are gradually curved.

15. An axial flow turbine as set forth in claim 10 wherein a portion of each blade adjacent the tip of the blade is gradually curved rearwardly.

16. An axial flow turbine as set forth in claim 10 wherein said means adding mass takes the form of an annular ring interconnecting the blade tips.

17. An axial flow turbine as set forth in claim 10 wherein the length and angle of the rake portions of the blades and the tip mass are selected such that blade tip centrifugal and wind forces are balanced and movement of the tips relative to the hub is insignificant at operating speed.
wherein an accelerator mounted on a tower supports the turbines on opposite sides thereof.

19. An axial flow turbine as set forth in claim 10 wherein at least each blade tip portion is displaced forwardly in a radial plane and in the direction of rotation.

20. An axial flow turbine for use in wind turbine electrical generating systems comprising a hub mounted for rotation about an axis and carrying a plurality of narrow radially elongated wind responsive blades with their tips at least partially unequally circumaxially spaced in driving relationship there about, each blade having a root portion connected with and supported by the hub and a remote tip portion spaced radially outwardly from the root portion, the cross sectional configuration of the blades between their root and tip portions being such that wind impinging thereon results in a substantial aggregate torque rotating the blades and hub in one direction.

21. An axial flow turbine as set forth in claim 20 wherein the unequal spacing is at least 0.5 percent and less than three percent of the angular spacing between the blades.

22. An axial flow turbine as set forth in claim 21 wherein the spacing between blades varies by one degree.

23. An axial flow turbine as set forth in claim 20 wherein the spacing between blades at their root portions connecting with the hub is unequal.

24. An axial flow turbine as set forth in claim 20 wherein the blade tip spacing is unequal but the root spacing is equal.

25. An axial flow turbine as set forth in claim 20 wherein a pair of turbines are provided each with the characteristics set forth, and wherein an accelerator mounted on a tower supports the turbines on opposite sides thereof.

26. An axial flow turbine as set forth in claim 20 wherein each blade tip portion is forwardly swept in a radial plane and in the direction of rotation, and means adding mass at the tips of the blades whereby to increase the centrifugal force generated during rotation and urge the blades radially in a direction opposite the direction of rotation and toward a linear centerline condition.

27. An axial flow turbine as set forth in claim 20 wherein each blade has a rake profile displaced rearwardly in an axial plane and in a downwind direction, and means is provided to add mass at the tips of the blades whereby to increase the centrifugal force generated during rotation and urge the blades radially in a direction opposite wind flow.

28. An axial flow turbine as set forth in claim 27 wherein each blade is forwardly swept in a radial plane and in the direction of rotation.
